(19) United States
(12) Patent Application Publication
(10) Pub. No.: US 2026/0357965 A1
(43) Pub. Date: Nov. 12, 2026

(54) PIXEL LIGHTING MODULE

(71) Applicant: Hyundai Mobis Co., Ltd., Seoul (KR)

(72) Inventor: Myeong Je KIM, Yongin-si (KR)

(73) Assignee: Hyundai Mobis Co., Ltd., Seoul (KR)

(21) Appl. No.: 19/412,137

(22) Filed: Dec. 8, 2025

(30) Foreign Application Priority Data
May 9, 2025 (KR) 10-2025-0060261

(51) Int. Cl. F21S 41/663; B60Q 1/08; B60Q 1/50; F21S 43/10; F21W 103/60; G09G 3/32; G09G 3/34

(52) U.S. Cl. CPC F21S 41/663; B60Q 1/08; B60Q 1/50; F21S 43/10; G09G 3/32; G09G 3/346; F21W 2103/60; G09G 2320/0242; G09G 2320/0666; G09G 2330/021; G09G 2370/10; G09G 2380/10

(57) ABSTRACT

The present invention relates to a pixel lighting module, and more specifically, to a pixel lighting module including at least one light driving device, at least one memory storing image data, and a controller configured to control the light driving device based on a control signal, wherein the controller is connected to the light driving device through a first interface and is configured to access the memory through the light driving device, and the light driving device is connected to the memory through a second interface and is configured to directly access the memory through the second interface to retrieve the image data.

### CROSS REFERENCE TO RELATED APPLICATION

The present application claims priority to Korean Patent Application No. 10-2025-0060261, filed May 9, 2025, the entire contents of which is incorporated herein for all purposes by this reference.

### BACKGROUND

### Field

The present invention relates to a pixel lighting module, and more specifically, to a high-resolution pixel lighting module.

### Description of the Related Art

Communication lamps play a crucial role in vehicles and are used as devices for transmitting various signals for visual communication between road users. Conventional communication lamp systems are typically connected to a controller and serve to convey various intentions through light. A vehicle controller serves to process basic control signals and images and transmits the signals to lamps. In conventional technologies, such a system indicates a driver's intentions or a state of a vehicle by performing relatively simple functions. However, as the need for communication lamps capable of complex visual communication, such as high-resolution pixel output, increases, the limitations of the conventional systems are becoming apparent.

Technological trends have led to the emergence of communication lamp systems using high-resolution pixels. For example, methods using a digital micromirror display (DMD) or a high-definition (HD) micro light emitting diode (LED) technology are included in this category. These systems can transmit high-resolution images instead of conventional simple LED lamps, enabling more detailed and sophisticated communication between vehicles. High-resolution pixel systems can output images with greater precision, allowing drivers to more clearly indicate messages to other road users.

However, these high-resolution communication lamp systems face several problems when processing large amounts of data. First, there are limitations in data transmission rate and processing capacity. Real-time processing of high-resolution images requires a significantly high data transmission rate, which cannot be addressed with conventional low-speed data interfaces. For example, the conventional low-speed data interfaces only process control signals and require a separate system for high-speed data transmission. In addition, to transmit image signals through a high-speed interface, a more complex system design can be required, thereby causing delays in communication between the vehicle controller and the high-resolution communication lamp.

Second, problems related to power consumption and heat generation caused by large-scale data processing are also present. To process and display high-resolution images in real time, a large amount of power consumes, which can increase heat generation of the system. The heat generation is a critical consideration in electronic devices, and efficient power management and cooling systems are essential to solve such a problem. In this regard, high-resolution communication lamp systems, which require large-scale processing, face the problem of being more complex and costly than conventional systems.

Third, there is also data distortion that occurs during real-time image correction and updating. High-resolution pixel systems require complex algorithms to correct image distortion, which directly impacts system processing speed. For example, a method of correcting an image by rearranging four corner points or extracting and transforming brightness values for each pixel can increase the system's burden. The delays in these complex data processing processes can hinder the reliable, real-time operation of communication lamps.

Consequently, communication lamp systems using high-resolution pixels have great potential, but face several technical problems in processing large amounts of data and updating images in real time. To solve these problems, more efficient data transmission methods, power management technologies, and improved image correction algorithms are needed.

### Documents of Related Art

[Patent Document] Korean Laid-Open Patent No. 10-2022-0091195 (“input device and method of vehicle,” published on Jun. 30, 2022) 2022.06.30)

### SUMMARY

The present invention is directed to providing a pixel lighting module that improves the efficiency of large-scale data transmission required for high-resolution image processing, enables real-time image processing, reduces system complexity by solving a separation problem between control signals and image signals, minimizes power consumption and heat generation, and enables more sophisticated communication.

According to various embodiments of the present invention, there is provided a pixel lighting module includes at least one light driving device; at least one memory storing image data; and a controller configured to control the at least one light driving device based on a control signal, wherein the controller is connected to the at least one light driving device through a first interface and is configured to access the at least one memory through the at least one light driving device, and wherein the at least one light driving device is connected to the at least one memory through a second interface and is configured to directly access the at least one memory through the second interface to retrieve the image data.

A data transmission rate of the first interface may be lower than a data transmission rate of the second interface.

The light driving device may be configured to transmit a clock signal to the memory, synchronize a transmission timing of the image data stored in the memory, and increase a transmission rate of the image data by increasing a frequency of the clock signal.

The light driving device may be configured to transmit a clock signal to the memory and synchronize a transmission timing of the image data such that the image data is transmitted at both rising and falling edges of the clock signal.

The at least one light driving device may include a plurality of light driving devices, the at least one memory includes a plurality of memory areas, the plurality of light driving devices correspond one-to-one to the plurality of memory areas, and display areas of light sources driven by each light driving device are different from one another.

The controller may be configured to generate corrected image data based on received updated image and transmit the corrected image data to the at least one memory through the at least one light driving device.

The controller may be configured to analyze the received updated image on a packet-by-packet basis, extract RGB data of each pixel in each packet, transform the extracted RGB data into brightness data, correct the brightness data to generate corrected image data, and transmit the corrected image data to the at least one light driving device on a packet-by-packet basis.

The controller may be configured to designate a plurality of reference points in the updated image, calculate a transformation matrix based on the designated plurality of reference points, and transform the brightness data using the calculated transformation matrix to generate the corrected image data.

The transformation matrix may be a perspective transformation matrix calculated from at least four reference points.

The corrected image data may be stored in the at least one memory in a pre-transformed state such that the at least one light driving device can output the corrected image data in real time without performing runtime warping or graphics-engine processing.

The pixel lighting module may further include at least one light source connected to and driven by the at least one light driving device, wherein the at least one light source comprises high-definition micro-LEDs or a digital micromirror device.

The first interface may be a serial peripheral interface (SPI) and the second interface is a quad SPI (QSPI) operating at least at 40 MHz.

The at least one light driving device may be implemented as an application-specific integrated circuit (ASIC) optimized for high-speed image data retrieval and light-source driving.

### BRIEF DESCRIPTION OF THE DRAWINGS

FIG. 1 is a schematic diagram illustrating a conventional pixel lighting module.

FIG. 2 is a schematic diagram illustrating a pixel lighting module according to the present invention.

FIG. 3 is a diagram illustrating data transmission timing of a second interface according to the present invention.

FIG. 4 is a schematic diagram illustrating a high-speed data transmission structure using a multi-region-based optical driver and multiple memories according to the present invention.

FIG. 5 is a schematic diagram illustrating an image data processing and transmission structure of a controller according to the present invention.

FIG. 6 is a schematic diagram comparing before and after image correction according to the present invention.

### DETAILED DESCRIPTION

To describe the present invention, operational advantages of the present invention, and objects achieved by the implementation of the present invention, hereinafter, exemplary embodiments of the present invention will be exemplified and described with reference to the embodiments.

First, terms used in this application are only used to describe specific embodiments and are not intended to limit the present invention, and singular expressions may include plural expressions unless the context clearly indicates otherwise. In addition, in this application, it should be understood that terms such as “comprise” or “have” are intended to specify that a feature, a number, a step, an operation, a component, a part, or a combination thereof described in the specification is present, but do not preclude the possibility of the presence or addition of one or more other features, numbers, steps, operations, components, parts, or combinations thereof.

In describing the present invention, when it is determined that the detailed description of related known configurations or functions may obscure the gist of the present invention, detailed description thereof will be omitted.

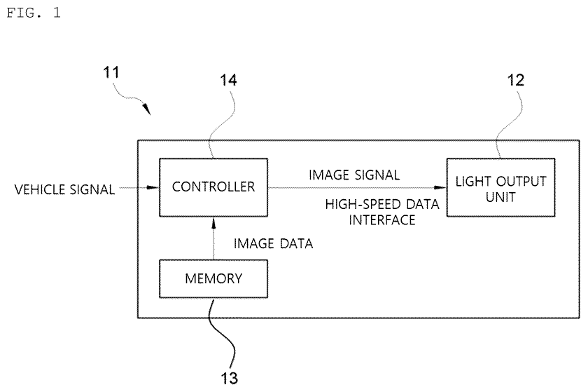

FIG. 1 is a schematic diagram illustrating a conventional pixel lighting module.

As illustrated in FIG. 1, a conventional pixel lighting module 11 may include a light output unit 12, memory 13, and a controller 14.

The memory 13 in which image data is stored is connected to the controller 14 and provides image data to be transmitted to the light output unit 12. That is, the light output unit 12 needs to receive the image data stored in the memory 13 through the controller 14 to output an image, and to this end, a high-speed data interface between the controller 14 and the light output unit 12 is essential.

Typically, the memory is connected to a microcontroller (MCU), and low-cost MCUs often provide only a low-speed data interface. Due to the data transmission limitations of the low-speed interface, the number of pixels and frame rate to be controlled by the light output unit 12 are constrained. For example, when a serial peripheral interface (SPI) that transfers data at 10 Mbps is used, the maximum number of controllable pixels at 30 fps is only about 33,333 according to the calculation data presented in the following Table 1.

TABLE 1

| item | Value | Unit | remarks |
|---|---|---|---|
| Number of frames | 30 | Fps | |
| per second | | | |
| Pixel depth | 8 | Bit per pixel | |
| SPI transmission | 10 | Mbyte | |
| rate | | | |
| Transmission | 20% | | |
| overhead | | | |
| Frame | 0.033333333 | Sec | |
| transmission time | | | |
| Bit transmission | 0.1 | μsec | Number of |
| time | | | frames/sec |
| Bit per frame | 333,333 | | Data transmission |
| | | | rate/sec |
| Actual bit per | 266,667 | | Bit per frame- |
| frame (excluding | | | overhead |
| overhead) | | | |
| pixel | 33,333 | pixel | Actual bit/pixel |
| | | | depth |

To solve the problem, that is, to increase the number of controllable pixels, a transmission rate of a data line that transfers image data needs to be increased, and in particular, high-speed data processing is essential to smoothly transmission large amounts of data between the controller 14 and the light output unit 12. Accordingly, the controller 14 requires a high-performance MCU or an application processor (AP), which increases the design complexity of the controller 14 and forces the use of specific, high-spec hardware, limiting system flexibility.

In addition, the maximum number of controllable pixels is constrained by the limited transmission rate of the data line, and to address this limitation, a high-performance controller including a large internal memory and graphics engine is required. Accordingly, the price of the controller increases and the material costs of the entire system also increase.

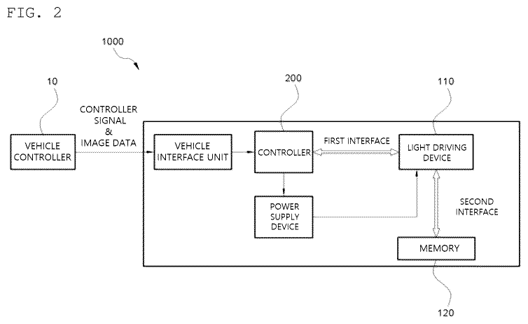

FIG. 2 is a schematic diagram illustrating a pixel lighting module according to the present invention.

As illustrated in FIG. 2, a pixel lighting module 1000 according to the present invention may include a light driving device 110, a memory 120, and a controller 200.

The light driving device 110 may be configured as at least one driver and may control an optical device, such as a high-definition (HD) micro light emitting diode (LED) or a digital micromirror device (DMD). In addition, the light driving device 110 may be implemented based on an application-specific integrated circuit (ASIC) to optimize specific calculations.

The memory 120 may be configured as at least one memory and may store predetermined image data.

The controller (MCU) 200 may control the light driving device 110 based on received control signals. In this case, the control signals may be received from a vehicle controller 10.

In this case, the light driving device 110 may be a module formed integrally with a light source (not illustrated), or may further include at least one light source (not illustrated) connected to the light driving device 110.

Hereinafter, the pixel lighting module according to the present invention will be described in detail.

The light driving device 110 may be connected to the controller 200 and the memory 120.

More specifically, the controller 200 may be connected to the light driving device 110 through a first interface and may indirectly access the memory 120 through the light driving device 110 rather than directly accessing the memory 120.

In addition, the light driving device 110 may be connected to the memory 120 through a second interface and may directly access the memory through the second interface and receive image data.

In this case, a data transmission rate of the first interface is preferably lower than that of the second interface, and for example, the first interface may be an SPI, and the second interface may be a quad SPI (QSPI).

Accordingly, the controller 200 may transmit only control signals to the light driving device 110 through the first interface, and the light driving device 110 may directly access and process necessary image data in the memory 120 through the second interface.

Conventionally, data transmission is performed using the SPI, but the low transmission rate of the SPI limits the number of controllable pixels in high-resolution pixel lighting devices. As described above, the maximum number of controllable pixels through the SPI at 30 fps is only 33,333.

In the present invention, a QSPI (40 MHz) is applied as the second interface, enabling data transmission four times faster than the SPI and controlling up to 133,333 pixels at 30 fps. This provides the effect of increasing the number of controllable pixels in proportion to the increased transmission rate of the data line. That is, the number of pixels increases from 33,333 to 133,333, which indicates a substantial performance improvement through the high-speed data interface. Meanwhile, the low-speed data interface (SPI) remains connected to the controller and may be used for transmitting control signals.

According to the calculation data presented in the following Table 2, 8 bits of data are required per pixel at 30 fps, and at an SPI transmission rate of 40 Mbytes/s, the number of bits transmitted per frame is 1,333,333. Considering a 20% transmission overhead, the actual transmittable data volume is 1,066,667 bits, which corresponds to controllability of about 133,333 pixels when transformed into pixel levels. Accordingly, the QSPI may be used to allow four times more pixels to be controlled than using SPI, thereby significantly improving system performance.

TABLE 2

| item | Value | Unit | remarks |
|---|---|---|---|
| Number of frames | 30 | Fps | |
| per second | | | |
| Pixel depth | 8 | Bit per | |
| | | pixel | |
| SPI transmission | 40 | Mbyte | |
| rate | | | |
| Transmission | 20% | | |
| overhead | | | |
| Frame | 0.033333333 | Sec | |
| transmission time | | | |
| Bit transmission | 0.025 | μsec | Number of |
| time | | | frames/sec |
| Bit per frame | 1,333,333 | | Data transmission |
| | | | rate/sec |
| Actual bit per | 1,066,667 | | Bit per frame- |
| frame (excluding | | | overhead |
| overhead) | | | |
| pixel | 33,333 | pixel | Actual bit/pixel |
| | | | depth |

The pixel lighting module 1000 according to the present invention can reduce the burden on the controller 200 and implement higher pixel resolution. In the conventional method, the controller 14 needs to directly read and transmit data from memory, but in the present invention, the controller 200 simply transmits control signals, and the light driving device 110 receives data directly from the memory 120, thereby enabling smooth system operation even with the low performance of the controller 200 and reducing costs.

In addition, the conventional SPI method has the limited number of pixels due to the limitations of the data transmission rate, but the QSPI can be used to enable higher resolution and faster frame rates, thereby substantially improving performance.

Conclusively, the present invention provides a method of using a high-speed interface, that is, the second interface (QSPI), to directly connect the memory 120 to the light driving device 110, thereby significantly increasing the number of controllable pixels and the frame rate. In addition, the controller 200 operates to transmit and receive only control signals through the first interface (SPI), which is a low-speed interface, and directly obtain image data through the second interface (QSPI), which is a high-speed interface, thereby reducing the burden on the controller 200 and optimizing system performance.

Meanwhile, the light driving device 110 may transmit a clock signal to the memory 120 and synchronize the transmission timing of the image data stored in the memory 120. Specifically, an increase in a clock signal rate in the second interface allows more data to be transmitted within the same amount of time, thereby increasing the number of controllable pixels. A faster clock rate increases the amount of data that may be transmitted per unit time, which can improve resolution and frame rates.

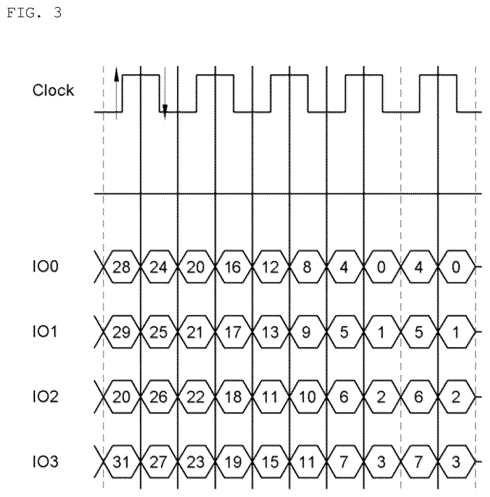

FIG. 3 is a diagram illustrating data transmission timing of a second interface according to the present invention.

As illustrated in FIG. 3, in addition to increasing the clock rate, the data transmission rate can be further increased by applying a double data rate (DDR) method. The conventional single data rate (SDR) method transmits data only at a rising edge of a clock, but the DDR method may transmit data at both rising and falling edges of the clock, doubling the amount of data that may be transmitted at the same clock rate. Accordingly, the number of controllable pixels may also increase, thereby implementing higher-resolution images.

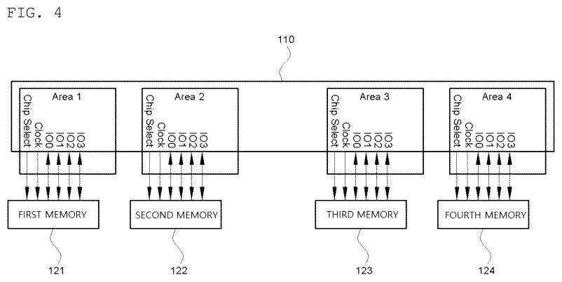

FIG. 4 is a schematic diagram illustrating a high-speed data transmission structure using a multi-region-based optical driver and multiple memories according to the present invention.

In the present invention, each of the light driving device 110 and the memory 120 may include a plurality of units, allowing independent data processing for each area. The conventional single interface method limits the number of controllable pixels due to the limitations of the data transmission rate, but in the present invention, each light driving device 110 may be connected to a separate memory 120 and may independently process data, thereby increasing transmission rate and achieving higher resolution.

Specifically, the pixel lighting module 1000 of the present invention includes a plurality of light driving devices 110 and a plurality of memory 120 areas, with each light driving device 110 configured to correspond one-to-one to a specific memory 120 area. Accordingly, display areas of a light sources driven by each light driving device 110 may be differently disposed, and independent data paths may be used, thereby preventing data collision and optimizing operating speed.

Each memory 120 may be directly connected to the corresponding light driving device 110 through the second interface (QSPI), which is a high-speed interface, and the light driving device 110 may perform data processing for each area based on a synchronized clock.

In addition, as illustrated in FIG. 4, when the memory 120 does not support multiple interfaces, in the present invention, a method of individually connecting the memory 120 to each interface may be applied to optimize data transmission rate. Accordingly, data bottlenecks can be reduced and the performance of the entire system can be improved compared to the conventional single interface method.

Conclusively, in the present invention, the plurality of light driving devices 110 and the plurality of memories 120 may be used to enhance the data processing performance of the pixel lighting module 1000 and enable each light driving device 110 to operate independently and to simultaneously perform synchronized data processing. Accordingly, it is possible to provide a pixel lighting structure capable of exerting optimal performance in various display and lighting systems requiring high resolution and high-speed response.

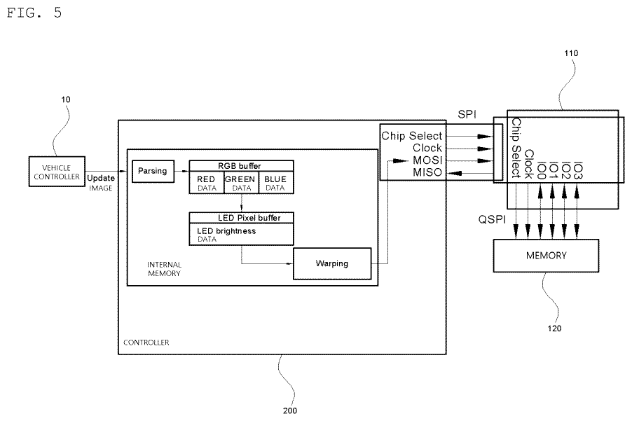

FIG. 5 is a schematic diagram illustrating an image data processing and transmission structure of a controller according to the present invention.

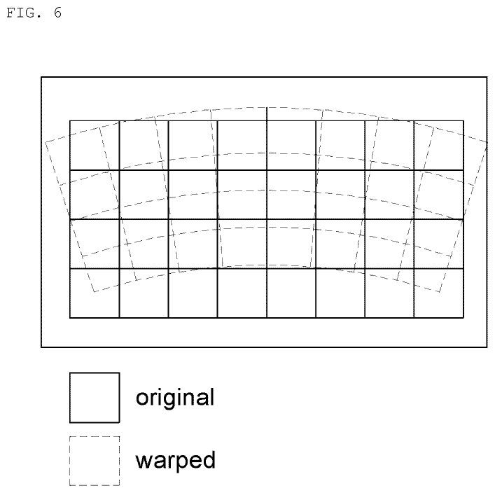

FIG. 6 is a schematic diagram comparing before and after image correction according to the present invention.

As illustrated in FIG. 5, the controller 200 may receive and process an updated image to generate corrected image data, and then stores the corrected image data in the memory 120 through the light driving device 110. During this process, the controller 200 may analyze the received image data and, if necessary, perform image correction to provide optimized data. In this case, the updated image may be received from the vehicle controller 10.

When receiving the updated image, the controller 200 may analyze the updated image on a packet-by-packet basis, individually extract RGB data for each pixel, and transform the RGB data into pixel brightness data. In this case, the input updated image may include distortion compared to the original image, and a predetermined algorithm needs to be applied to correct this distortion to maintain data consistency. However, when warping (correction) is performed in advance by the vehicle controller 10 or an over-the-air (OTA) server, separate processing by the controller 200 is not required. A position of warping being performed is not limited to a specific stage, and as long as lamp mounting information and an illumination angle are known, warping may be performed at any of the vehicle controller 10, the OTA server, or the controller 200. In particular, when real-time warping is required using a vehicle sensor, it is necessary to include this in the controller 200, but when pre-calculation is possible, warping may be processed at a different stage, and the pixel lighting module 1000 or the light driving device 110 may be configured to directly use the corrected data.

Specifically, the controller 200 divides the received image data into packets of a predetermined size and processes the divided image data on an individual pixel basis. Each packet may include pixel position information, RGB color values, and related metadata and based on these, may be transformed into pixel-specific brightness data. Pixel brightness transformation includes adjusting colors according to the display characteristics and light source characteristics, and in particular, LED-based display devices require the optimization of the brightness of individual pixels to maintain color uniformity.

The transformed brightness data is not used, but is subjected to an additional image correction process to generate final corrected image data. This corrects geometric distortion, color imbalance, and distortions due to a curvature of a display surface, and the like, which may occur in a pixel array. The corrected data is transmitted to the light driving device (high-resolution pixel lighting device) on a packet-by-packet basis to display accurate images. Accordingly, more precise light control can be performed at each pixel.

In particular, the controller 200 adopts a method of designating a plurality of reference points during the image correction process, calculating a transformation matrix based on these reference points, and then transforming the brightness data using the transformation matrix. For example, in the case of vehicle headlamps, image patterns may be distorted depending on a road surface slope, vehicle movement, and an illumination angle, and this distortion needs to be corrected to output an accurate pattern.

To this end, as illustrated in FIG. 6, the controller 200 sets four or more reference points in an input image and performs perspective transformation with respect to these reference points to calculate the transformation matrix. The transformation matrix quantitatively models the deformation of the pixel array and is used to adjust the input image data to generate corrected data in real time. During this process, a multi-level image correction algorithm including pixel-level color and brightness adjustments is applied, enabling the pixel lighting module 1000 to output accurate patterns.

Consequently, the pixel lighting module 1000 of the present invention may implement high-resolution, precise pixel lighting by integrating real-time analysis of updated images, pixel brightness transformation, distortion correction based on a transformation matrix, and packet-level data transmission.

In addition, the pixel lighting module 1000 of the present invention may use corrected image data in real time without a graphics engine. Typical systems including a graphics engine (GPU or high-performance AP) may perform warping and other graphics operations in real time, but in the present invention, as illustrated in FIG. 5, the controller 200 performs correction to generate corrected image data and stores the corrected image data in the memory 120 through the light driving device 110, thereby enabling the corrected data to be immediately output without additional graphics operations during execution. That is, the correction calculation may be configured to store image data in a pre-transformed state, rather than transforming the image data in real time so that the image data may be directly output from the light driving device 110. Warping does not rely on specific hardware and may be implemented to be processed by the OTA server or the vehicle controller 10 and then used directly by the pixel lighting module 1000 or the light driving device 110.

Conclusively, the pixel lighting module 1000 of the present invention can output accurate light patterns in real time using the corrected image data even in an environment without a graphics engine, thereby optimizing pixel lighting performance and implementing real-time, precise light control in various application fields.

Meanwhile, the functions of the controller 200, such as real-time analysis of the updated image, pixel brightness transformation, and distortion correction based on the transformation matrix, may be performed by the vehicle controller 10, or may be performed separately from the vehicle controller 10 for each function.

In the pixel lighting module according to various embodiments of the present invention, it is possible to implement high-resolution pixels through the high-speed data interface, thereby solving the performance degradation problem that can occur in systems connected to conventional low-speed data interfaces. Accordingly, high-resolution images can be stably processed, and clearer communication signals can be provided.

In addition, by using direct memory access, data can be processed through the high-speed data interface without going through the controller, thereby significantly improving system efficiency. Accordingly, it is possible to enable faster data transmission rates and real-time image processing, thereby implementing faster communication speeds.

Although the exemplary embodiments of the present invention have been described above, the embodiments disclosed in the present invention are not intended to limit the technical spirit of the present invention but are only for description. Accordingly, the technical spirit of the present invention includes not only each disclosed embodiment, but also a combination of the disclosed embodiments, and furthermore, the scope of the technical spirit of the present invention is not limited by these embodiments. In addition, those skilled in the art to which the present invention pertains can variously change and modify the present invention without departing from the spirit and scope of the appended claims, and all such appropriate changes and modifications should be regarded as belonging to the scope of the present invention as equivalents.

### DESCRIPTION OF REFERENCE NUMERALS

10: vehicle controller
11: conventional pixel lighting module
12: light output device
13: memory
14: controller
1000: pixel lighting module
100: light output device
110: light driving device
120: memory
121: first memory
122: second memory
123: third memory
124: fourth memory
200: controller

What is claimed is:

1. A pixel lighting module comprising:
at least one light driving device;
at least one memory storing image data; and
a controller configured to control the at least one light driving device based on a control signal,
wherein the controller is connected to the at least one light driving device through a first interface and is configured to access the at least one memory through the at least one light driving device, and
wherein the at least one light driving device is connected to the at least one memory through a second interface and is configured to directly access the at least one memory through the second interface to retrieve the image data.

2. The pixel lighting module of claim 1, wherein a data transmission rate of the first interface is lower than a data transmission rate of the second interface.

3. The pixel lighting module of claim 1, wherein the light driving device is configured to transmit a clock signal to the memory, synchronize a transmission timing of the image data stored in the memory, and increase a transmission rate of the image data by increasing a frequency of the clock signal.

4. The pixel lighting module of claim 1, wherein the light driving device is configured to transmit a clock signal to the memory and synchronize a transmission timing of the image data such that the image data is transmitted at both rising and falling edges of the clock signal.

5. The pixel lighting module of claim 1, wherein the at least one light driving device includes a plurality of light driving devices,
the at least one memory includes a plurality of memory areas,
the plurality of light driving devices correspond one-to-one to the plurality of memory areas, and
display areas of light sources driven by each light driving device are different from one another.

6. The pixel lighting module of claim 1, wherein the controller is configured to generate corrected image data based on received updated image and transmit the corrected image data to the at least one memory through the at least one light driving device.

7. The pixel lighting module of claim 6, wherein the controller is configured to analyze the received updated image on a packet-by-packet basis, extract RGB data of each pixel in each packet, transform the extracted RGB data into brightness data, correct the brightness data to generate corrected image data, and transmit the corrected image data to the at least one light driving device on a packet-by-packet basis.

8. The pixel lighting module of claim 7, wherein the controller is configured to designate a plurality of reference points in the updated image, calculate a transformation matrix based on the designated plurality of reference points, and transform the brightness data using the calculated transformation matrix to generate the corrected image data.

9. The pixel lighting module of claim 8, wherein the transformation matrix is a perspective transformation matrix calculated from at least four reference points.

10. The pixel lighting module of claim 6, wherein the corrected image data is stored in the at least one memory in a pre-transformed state such that the at least one light driving device can output the corrected image data in real time without performing runtime warping or graphics-engine processing.

11. The pixel lighting module of claim 1, further comprising at least one light source connected to and driven by the at least one light driving device, wherein the at least one light source comprises high-definition micro-LEDs or a digital micromirror device.

12. The pixel lighting module of claim 1, wherein the first interface is a serial peripheral interface (SPI) and the second interface is a quad SPI (QSPI) operating at least at 40 MHz.

13. The pixel lighting module of claim 1, wherein the at least one light driving device is implemented as an application-specific integrated circuit (ASIC) optimized for high-speed image data retrieval and light-source driving.
